(19) United States
(12) Patent Application Publication
(10) Pub. No.: US 2005/0114136 A1
(43) Pub. Date: May 26, 2005

(54) Manipulating wavetable data for wavetable based sound synthesis

(76) Inventors: Matti S. Hamalainen, Lempaala (FI); Marius Tico, Tampere (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/723,242

(22) Filed: Nov. 26, 2003

(51) Int. Cl. G10L 13/00

(52) U.S. Cl. 704/258

(57) ABSTRACT

In wavetable based sound synthesis, the wavetable data may comprise samples in a loop section, which samples may be reused for a playback in a loop as often as required. According to a first aspect of the invention, it is proposed that the internal state of a decoder operating on a frame-by-frame basis is restored before each repetition of a decoding of a stored encoded frame comprising the beginning of a loop section. According to a second aspect of the invention, the original wavetable data is padded at the beginning before encoding the wavetable data on a frame-by-frame basis for storage, such that all samples of the loop section are included in a single frame, if possible. According to a third aspect of the invention, a last, possibly incomplete frame provided for encoding is filled up with samples resulting from a periodic extension of the loop section.

### FIELD OF THE INVENTION

The invention relates to the field of wavetable based sound synthesis and more specifically to methods for use in a wavetable based sound synthesis, wherein wavetable data may comprise samples in an attack section and samples in a loop section, and wherein the samples of the loop section may be reused for a playback in a loop as often as required. The invention relates equally to corresponding devices, to corresponding wavetable based sound synthesis systems and to corresponding software program products.

### BACKGROUND OF THE INVENTION

Wavetable based sound synthesis is used for example in mobile telecommunication terminals. It has the advantage that a very high sound synthesis quality can be achieved with a rather simple algorithm, which basically relies on processing and playing back previously recorded audio samples, called wavetables.

For the purpose of a music synthesis, the wavetables store the tones of real instruments that are recorded under different conditions, for instance using different pitches or musical notes, different note velocities, etc. The wavetables capture the timbre of the real instrument and allow thereby a very realistic reproduction of a musical performance. Before the wavetables are actually included into the output audio sound, the raw wavetable data undergoes several signal processing operations, including, for example, an amplitude modulation for the purpose of modeling the envelope of the output audio waveform, filtering, etc.

The main drawback of a wavetable sound synthesis is the large amount of memory needed to store the individual wavetables. For instance, in order to ensure a high synthesis quality for a musical performance, a large number of wavetables recording the instruments playback under different conditions must be stored. Memory space, however, is at a premium in some devices, and hence recording the sound of instruments under all possible conditions may not be feasible.

Consequently, it is an aim to keep the stored wavetable data as small as possible while ensuring at the same time a high quality of the playback. Several techniques are used in practical implementations which allow to reduce the memory requirements for wavetable synthesis.

One known technique is pitch-shifting, which transposes the pitch of a recorded note by decimating and interpolating the corresponding wavetable data. Thereby, not only the recorded note can be reproduced based on a given wavetable, but equally higher or lower notes. This technique allows a significant reduction of the number of wavetables stored for each instrument, although it may sacrifice to some extent the quality of the synthesized sound.

Another well known technique is looping, which exploits the property of some instruments to enter a stationary phase after a short non-stationary attack section of their sound. Regardless of the duration of a certain note, a wavetable is stored which comprises the attack section of the note and in addition a loop section, which consists of a single copy of the fundamental period of the stationary part of the sound wave of the note. FIG. 1 is a diagram illustrating by way of example an attack section and a loop section which may be stored for the purpose of looping in a wavetable. During playback, a control logic repeats this loop section in a loop until the desired note ends. Consequently, relatively short wavetables can be stored regardless of the duration of a note for which the wavetable is stored.

Looping has also been described in U.S. Pat. No. 6,239,345 B1, where side effects due to looping discontinuities have been mentioned, and where further a method for eliminating such discontinuities has been presented.

Another technique that allows to reduce the memory requirements for wavetable synthesis is to store the wavetable data in a compressed form into the memory, and to decode only those portions of the encoded wavetable data that are required during playback. In order to accomplish this, some compression scheme must be used. A simple compression scheme is, for instance, A/μ-law presented in ITU-T Recommendation G.711: “Pulse code modulation (PCM) of voice frequencies”. According to this compression approach each data sample is processed, i.e. encoded or decoded, independently of other samples, and hence there is no difficulty in localizing and decoding the specific data samples that are needed during the playback. Moreover, using this compression scheme it is rather trivial to localize a loop start and end points of the wavetable, and further to decode the loop section as many times as required during the playback.

In spite of this advantage, which is due to the simplicity of the scheme, the A/μ-law encoding might not be the preferred compression scheme on some platforms, because it has rather poor compression performance. Often, a more advanced compression technique might be preferred in order to be able to store more wavetable data in the same memory, or in order to reduce the memory requirements for wavetable data storage. Such more advanced audio encoding techniques are for example AMR-WB, presented in ITU-T Recommendation G.722.2: “Wideband coding of speech at around 16 kbit/s using Adaptive Multi-rate Wideband (AMR-WB)”, as well as ADPCM, presented in ITU-T Recommendation G.726: “40, 32, 24, 16 kbit/s Adaptive Differential Pulse Code Modulation (ADPCM)”.

A difficulty in utilizing such advanced audio coders arises from the fact that the decoding process cannot be carried out independently for each sample. Advanced audio coders exploit the correlation between audio samples in order to achieve a higher compression performance. As a consequence the decoded sample values delivered by such a decoder depend not only on the input encoded stream of data but also on an internal state of the decoder which evolves during the decoding process. Because of this, a repetitive decoding of the loop section, for instance, is no longer a trivial matter, since the state of the decoder at the end of the loop is different from its state at the beginning of the loop.

Another, more important difficulty in utilizing advanced compression schemes for handling compressed wavetable data, arise from the fact that most of these schemes perform the encoding and decoding operations on a frame-by-frame basis, wherein a frame comprises one or more consecutive audio samples. Any manipulation of an encoded wavetable comprising attack and loop sections must therefore take into consideration that the decoder can provide only an integer number of decoded audio frames at a time. For example, the loop section of a wavetable might be distributed into several frames, and, in addition, it might be too long to be stored entirely in the decoded form into the memory. Consequently, in such a case it is necessary to decode the frames composing the loop section several times in a row as required during playback. Delivering the same decoded loop waveform every time, however, is rendered difficult by the evolving internal state of the decoder. On the other hand, boundary distortions may also occur in the looping, in case the last frame of data is incomplete, that is, if the loop section does not fill up completely the last frame of a wavetable.

Finally, it has to be noted that the frame size is specific to the compression scheme employed, and usually it cannot be changed during processing. For example, a frame in the AMR-WB scheme comprises 320 decoded audio samples, whereas in the ADPCM scheme a frame consists of a single audio sample.

### SUMMARY OF THE INVENTION

The invention enables the use of a frame-based audio coding of wavetable data, wherein a frame comprises one or more data samples, and wherein the wavetable data may include a loop section. The invention allows in particular to decode portions of encoded wavetable data as needed during playback. The invention further allows in particular to prepare the wavetable data before a frame based encoding in a way which reduces the computational effort during decoding and which eliminates possible boundary distortions.

A first aspect of the invention relates to decoding encoded wavetable data, while a second and a third aspect of the invention relate to encoding wavetable data in the case when the frame size used by the encoding algorithm is larger than one sample. All three aspects of the invention are based on the consideration that most of the state-of-the-art audio coding schemes work on a frame-by-frame basis. In the encoding stage, these coding schemes first divide the input audio stream into frames of a certain size, and encode then each such frame either independently or not with respect to neighborhood frames. In the decoding stage, these coding schemes are only able to provide an integer number of decoded audio frames. The interdependence between neighborhood frames are reflected together with other control information in a number of variables that constitute a so called internal state of the decoder.

For the first aspect of the invention, a method for use in a wavetable based sound synthesis for which encoded wavetable data is decoded by means of an audio decoder on a frame-by-frame basis, each frame comprising at least one sample, is proposed. The encoded wavetable data comprises samples in an attack section and samples in a loop section, and the samples of the loop section may be reused for a playback in a loop as often as required. The proposed method comprises the following steps:
a) decode consecutive frames of the encoded wavetable data starting with a first frame up to a frame which includes a start of a loop section;
b) save an internal state of the audio decoder before starting to decode the frame that includes the start of the loop section;
c) decode subsequently all frames comprising samples of the loop section and provide the decoded frames for further processing for a playback; and
d) at least if the samples of the loop section are distributed to more than one frame, restore the internal state of the audio decoder, saved at step b), and continue with step c) as often as required.

For the first aspect of the invention, moreover a device is proposed, which comprises an audio decoder decoding received wavetable data on a frame-by-frame basis, each frame comprising at least one sample, wherein the encoded wavetable data may comprise samples in an attack section and samples in a loop section. The samples of the loop section may be reused for a playback in a loop as often as required. The proposed device further comprises a storage component for saving an internal state of the audio decoder and a controller. The controller causes the audio decoder to save an internal state of the audio decoder into the storage component before decoding a next frame, if the next frame includes a start of a loop section. The controller causes in addition the audio decoder to decode subsequently all frames comprising samples of the loop section and to provide the decoded frames for further processing for a playback. Finally, the controller causes the audio decoder as often as required to restore the internal state saved in the storage component and to repeat decoding subsequently all frames comprising the samples of the loop section.

For the first aspect of the invention, moreover a wavetable based sound synthesis system is proposed which comprises the components of the proposed device and in addition a storage component for storing encoded wavetable data and an encoder for encoding a wavetable on a frame-by-frame basis and for storing resulting wavetable data in this storage component. The audio decoder then decodes wavetable data provided by this storage component for storing encoded wavetable data.

For the first aspect of the invention, finally, a software program product is proposed in which a software code for supporting a wavetable based sound synthesis is stored. For the wavetable based sound synthesis encoded wavetable data is decoded by means of an audio decoder on a frame-by-frame basis, each frame comprising at least one sample, wherein the encoded wavetable data may comprise samples in an attack section and samples in a loop section. The samples of the loop section may be reused for a playback in a loop as often as required. The software code realizes the functions of the controller of the proposed device when running in a processing component which is connected to the audio decoder.

The first aspect of the invention proceeds more specifically from the consideration that encoder and decoder algorithms are deterministic. Thus, they will always deliver the same outcome for a given input, providing that they are starting from the same initial internal state. It is proposed that this property is exploited for unfolding the loop part of an encoded wavetable during playback. The frames comprising the loop section are decoded periodically one at a time, as often as required for a desired note. By restoring the internal state of the decoder each time before decoding the respective first frame comprising the loop section, the decoded loop will always resemble the same waveform.

It is an advantage of the first aspect of the invention that it allows to decode only those portions of compressed wavetable data which are respectively required during playback, maintaining thereby a low memory consumption.

The first aspect of the invention may be of advantage in decoding frames of any length, including one sample length frames. Even for frames having only a length of one sample, most advanced decoders use an internal decoder state for keeping track of the correlation between the samples. The decoded values provided by an ADPCM decoder, for example, which decodes one sample at a time, depends not only on the encoded input sample value but equally on the internal state of the decoder, which, in ADPCM, comprises linear prediction coefficients.

Each decoded frame is advantageously stored for the further processing by substituting a preceding frame in a storage component, and a respective next frame is advantageously only decoded at a time when samples of a further frame are needed. The storage component may then provide the samples of a respectively stored frame for further processing for a playback.

For the second aspect of the invention, a method for use in a wavetable based sound synthesis for which wavetable data is encoded for storage by means of an audio encoder on a frame-by-frame basis, wherein each frame comprises more than one sample, is proposed. The wavetable data comprises samples in an attack section and samples in a loop section, and the samples of the loop section may be reused for a playback in a loop as often as required. The proposed method comprises distributing, in this order, a certain number of padding samples, the samples of the attack section and the samples of the loop section to a sequences of frames. The certain number of padding samples is selected such that all samples of the loop section are included in a single frame in case the loop section comprises less samples than a respective frame. The proposed method further comprises encoding this sequence of frames by the audio encoder.

For the second aspect of the invention, moreover a device is proposed, which includes an audio encoder for encoding received wavetable data on a frame-by-frame basis, wherein each frame comprises more than one sample. The wavetable data may comprise samples in an attack section and samples in a loop section, and the samples of such a loop section may be reused for a playback in a loop as often as required. The audio encoder comprises a distributing component distributing, in this order, a certain number of padding samples, samples of an attack section of received wavetable data and samples of a loop section of received wavetable data to a sequences of frames, in case the received wavetable data includes an attack section and a loop section. The distributing component selects this certain number of padding samples such that all samples of the loop section are included in a single frame in case the loop section comprises less samples than a respective frame. The audio encoder further comprises an encoding component for encoding a sequence of frames provided by the distributing component.

For the second aspect of the invention, moreover a wavetable based sound synthesis system is proposed, which comprises a storage component for storing encoded wavetable data, the components of the device proposed for the second aspect of the invention and an audio decoder decoding wavetable data received from the storage component on a frame-by-frame basis and providing decoded wavetable data for further processing for a playback.

For the second aspect of the invention, finally, a software program product is proposed, in which a software code for supporting a wavetable based sound synthesis is stored. For the wavetable based sound synthesis, received wavetable data is encoded for storage by means of an audio encoder on a frame-by-frame basis, wherein each frame comprises more than one sample. The wavetable data may comprise samples in an attack section and samples in a loop section, and the samples of such a loop section may be reused for a playback in a loop as often as required. The software code realizing the functions of the distributing component of the audio encoder of the device proposed for the second aspect of the invention when running in a processing component of such an audio encoder.

The second aspect of the invention proceeds more specifically from the consideration that a favorable situation is achieved during decoding, when the entire loop section of a wavetable fits into one frame. In such a case, once the loop section has been decoded, there is no need to decode further frames for unfolding the loop part of the wavetable, since the samples of the same decoded frame can be reused as often as required. Usually, the frame length cannot be controlled. It can be ensured, however, that the loop data fits into a single frame whenever its size is smaller than the frame length. It is therefore proposed to align the frame boundaries such that the entire loop section is included in a single frame, if the size of the loop section is smaller than the size of the frame. This is achieved by including in front of the original wavetable data padding samples, for example padding samples having a value of zero, in order to translate all frame boundaries as much as necessary.

It is an advantage of the second aspect of the invention that it allows to reduce the computational complexity during the wavetable decoding process, since a repeated decoding of frames is avoided, if possible.

For the third aspect of the invention, a method for use in a wavetable based sound synthesis for which wavetable data is encoded for storage by means of an audio encoder on a frame-by-frame basis, wherein each frame comprises more than one sample, is proposed. The wavetable data comprises samples in an attack section and samples in a loop section, and the samples in the loop section may be reused for a playback in a loop as often as required. The proposed method comprises distributing the samples of the wavetable data to a sequences of frames. The proposed method further comprises extending the loop section periodically in order to fill up a last frame of the sequence of frames with the resulting samples. The proposed method further comprises encoding the sequence of frames.

For the third aspect of the invention, moreover a device including an audio encoder for encoding received wavetable data on a frame-by-frame basis, wherein each frame comprises more than one sample, is proposed. The wavetable data may comprise samples in an attack section and samples in a loop section. Samples of such a loop section may be reused for a playback in a loop as often as required. The audio encoder comprises a distributing component distributing samples of received wavetable data to a sequences of frames and, in case the received wavetable data comprises a loop section, extending the loop section periodically in order to fill up a last frame of the sequence of frames with the resulting samples. The audio encoder further comprises an encoding component encoding a sequence of frames provided by the distributing component.

For the third aspect of the invention, moreover a wavetable based sound synthesis system is proposed, which comprises a storage component for storing encoded wavetable data, the components of the device proposed for the third aspect of the invention and an audio decoder decoding wavetable data received from the storage component on a frame-by-frame basis and providing decoded wavetable data for further processing for a playback.

For the third aspect of the invention, finally, a software program product is proposed, in which a software code for supporting a wavetable based sound synthesis is stored, for which wavetable based sound synthesis received wavetable data is encoded for storage by means of an audio encoder on a frame-by-frame basis, wherein each frame comprises more than one sample. The wavetable data may comprise samples in an attack section and samples in a loop section, and the samples of such a loop section may be reused for a playback in a loop as often as required. The software code realizing the functions of the distributing component of the audio encoder of the device proposed for the second aspect of the invention when running in a processing component of such an audio encoder.

The third aspect of the invention proceeds more specifically from the consideration that padding a last incomplete frame prepared for a wavetable with some constant value before encoding, as usual, is unacceptable in the case of looping. Padding may result in severe distortions of a looped output sound, as the loop section is usually repeated several times during playback. It is therefore proposed to fill up the last, possibly incomplete, frame of a wavetable by periodically extending the loop section as much as necessary.

It is an advantage of the third aspect of the invention that it reduces the effect of boundary distortions which occur whenever the last frame of data is incomplete.

Some encoders collect the information needed to encode a frame from a windowed data segment larger than one frame.

For example, in AMR-WB, an overhead of 1/4th of the frame length, on either side of the frame, is considered in an autocorrelation computation, as described for example in ITU-T Recommendation G.722.2: “Wideband coding of speech at around 16 kbit/s using Adaptive Multi-rate Wideband (AMR-WB)”. In such cases, the periodic extension used according to the third aspect of the invention, is advantageously somewhat longer than required to fill up the last incomplete frame. The data exceeding the last frame boundary is not to be encoded. It is only intended to provide information for the encoding algorithm in order to avoid distortions in the last encoded frame of the wavetable.

It is an advantage of all three aspects of the invention that they can be used with almost any state-of-the-art audio encoder/decoder for the purpose of wavetable compression in wavetable sound synthesis, as they can be embedded into any wavetable based sound synthesize system that employs a frame based encoding and decoding. As the invention is not limited to a specific encoder/decoder, it offers the possibility to use and promote for the purpose of wavetable compression audio encoders/decoders already present in the systems in which the invention is to be used, for instance an AMR-WB encoder/decoder.

All three aspects of the invention can further be implemented in software and/or in hardware.

The three aspects of the invention can also be combined advantageously in a single system.

The respective proposed device can be in particular, though not exclusively, a mobile telecommunication terminal, in which the amount of wavetable data stored for a wavetable sound synthesis is to be reduced. The respective proposed system can be, for example, equally a mobile telecommunication terminal or part of a mobile telecommunication terminal or an assembly of several components or devices.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 is a diagram illustrating an exemplary wavetable composed of an attack section and a loop section;

FIG. 2 is a schematic block diagram of a wavetable based sound synthesis system in which an embodiment of the invention is implemented;

FIG. 3 is a flow chart illustrating an embodiment of the first aspect of the invention implemented in the system of FIG. 2;

FIG. 4 is a flow chart illustrating an embodiment of the second and the third aspect of the invention implemented in the system of FIG. 2; and

FIG. 5 is a diagram further illustrating the embodiment of the second and the third aspect of the invention presented in FIG. 4.

### DETAILED DESCRIPTION OF THE INVENTION

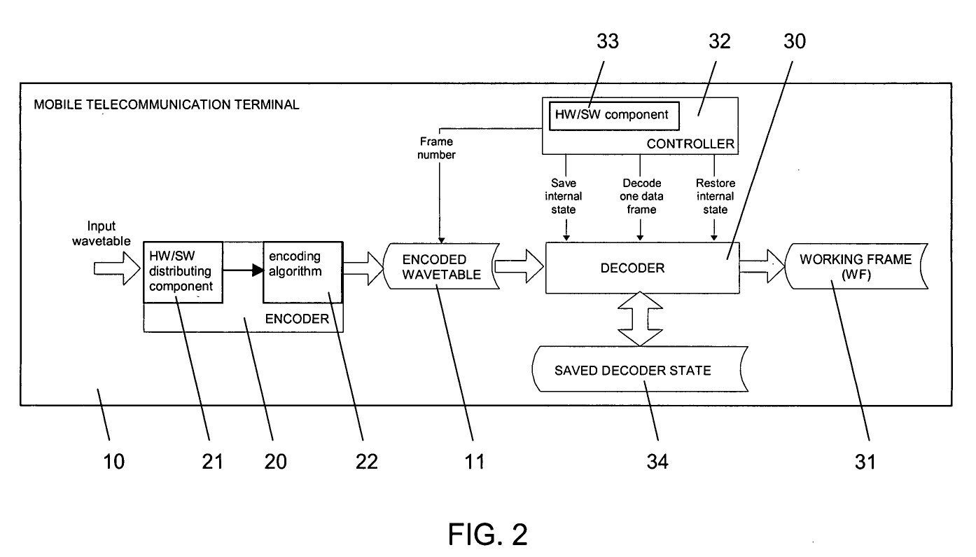

FIG. 2 schematically presents a wavetable based sound synthesis system according to the invention. The system can be for example a mobile telecommunication terminal 10 or include such a terminal.

The system comprises an audio encoder 20, which includes a distributing component 21 and an encoding algorithm 22. The audio encoder 20 is connected to a data storage component 11 for storing encoded wavetable data. Data storage component 11 is further connected via an audio decoder 30 to a data storage component 31 for storing a working frame (WF). The audio decoder 30 includes a decoding algorithm (not shown). The system comprises in addition a controller 32, which has a controlling access to data storage component 11 and to the audio decoder 30. Finally, the system comprises a data storage component 34 for saving a decoder state. Data storage component 34 is connected to the audio decoder 30.

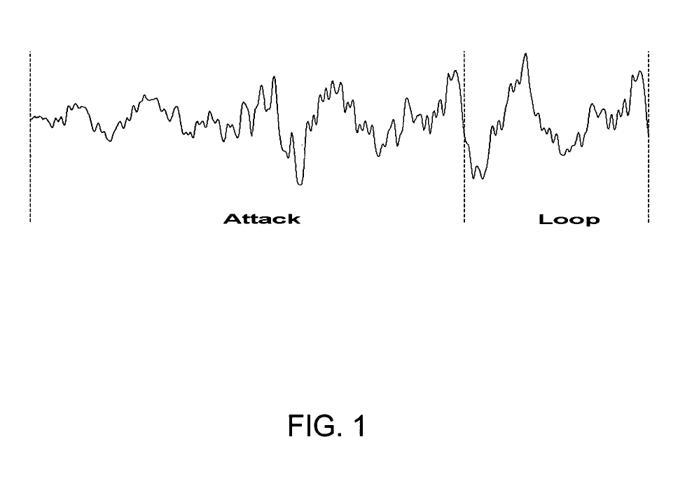

In the system of FIG. 2, input wavetables are encoded by the audio encoder 20 on a frame-by-frame basis for compressing the wavetable data and stored in data storage component 11 for later use. Each input wavetable may include an attack section and a loop section, as presented in FIG. 1. For a playback of a presentation, encoded wavetable data is extracted from the data storage component 11 and decoded by the audio decoder 30 on a frame-by-frame basis. Respectively one decoded frame is stored as working frame WF in data storage component 31. The working frame in data storage component 31 can then be processed for generating output audio frames for the playback. The generation of output audio frames may include unfolding a loop section of a wavetable by repeating the loop section as long as required. For the actual encoding and decoding, the audio encoder 20 and the audio decoder 30 can employ an encoding algorithm 22 and a decoding algorithm, respectively, known from the state of the art, for example AMR-WB coding algorithms.

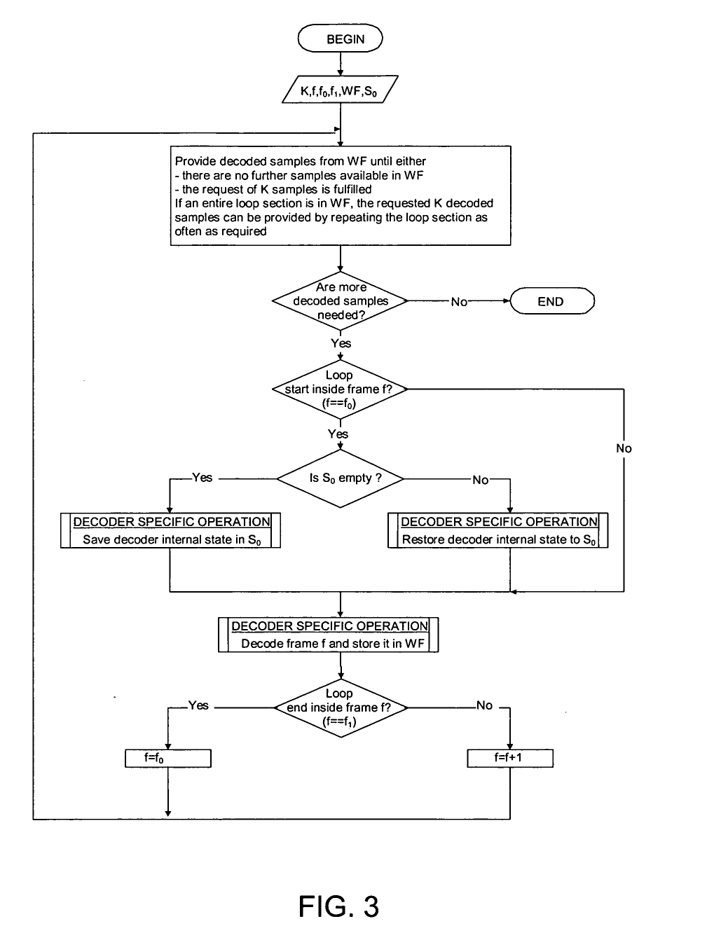

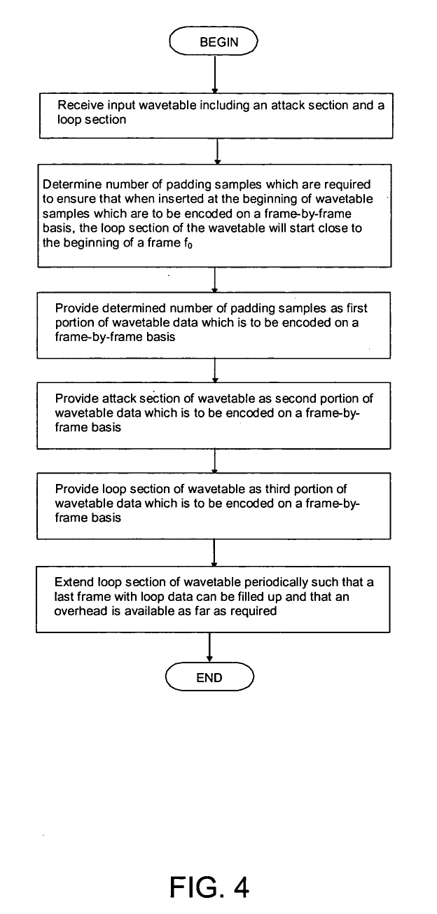

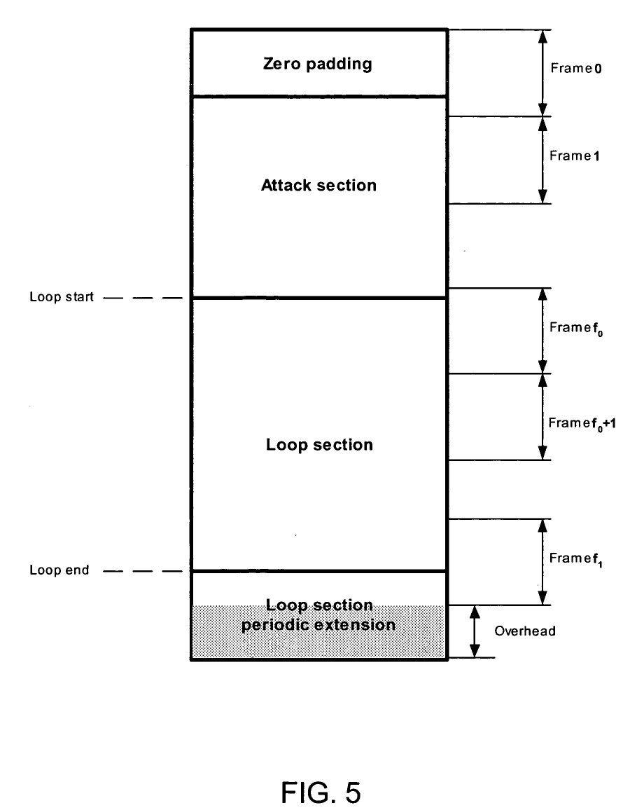

In the following, first the operation on the decoding side of the system of FIG. 2 will be explained with reference to FIG. 3, and then the operation on the encoding side of the system of FIG. 2 will be explained with reference to FIGS. 4 and 5.

FIG. 3 is a flow chart illustrating a procedure followed in the system of FIG. 2 in order to deliver decoded wavetable samples required for playback in accordance with the first aspect of the invention. Since the procedure can be used with almost any state-of-the-art audio compression scheme, the audio decoding mechanism is regarded as a “black box” that provides a rather minimal control interface for manipulation from the outside. The audio decoder 30 comprises more specifically a control interface which allows the audio decoder 30 to respond to three different control signals from the controller 32, namely the commands “save internal state”, “restore internal state” and “decode one frame”.

For the procedure of FIG. 3, various parameters are defined. Parameter K indicates the number of decoded samples which are requested for playback. Parameter f is the index of the respective next encoded frame of a wavetable. Parameter f₀ is the index of the frame which contains the loop start point in encoded wavetable data comprising a loop section. Parameter f₁ is the index of the frame which contains the loop end point in encoded wavetable data comprising a loop section. Parameters f₀ and f₁ are known at the controller 32 for each stored wavetable, while parameter K may be provided to the controller 32 in accordance with a desired presentation. The index f of the next frame to decode is calculated by the controller 32 taking into consideration the required loop unfolding during playback. WF is the working frame that contains the last decoded frame of the wavetable data. It is stored in data storage component 31 and it is empty until the audio decoder 30 has decoded the first frame. Finally, S₀ is the internal state of the audio decoder 30 before decoding the frame that contains the loop start. It is stored in data storage component 34.

For the processing of a specific wavetable, the controller 32 receives information on how many samples of this specific wavetable are required for a presentation.

The controller 32 then orders data storage component 11 to provide the first frame with encoded wavetable data of the specific wavetable to the audio decoder 30 and orders the audio decoder 30 to decode the received data frame. The audio decoder 30 decodes the received data frame in a known manner and provides the decoded data frame as working frame WF to data storage component 31.

The working frame WF in data storage component 31 provides immediate access to consecutive decoded wavetable samples during playback. Whenever there is a request for samples for playback, the system will try first to fulfill this request by delivering decoded samples that are already available in the working frame WF. The data storage component 31 thus provides decoded samples from the working frame WF for playback, until there are no further samples available in the working frame WF or until the request of K samples is fulfilled.

If an entire loop section of the wavetable is included in the working frame WF in data storage component 31, then the requested K decoded samples can be provided by repeating the loop section in the working frame WF as often as required without the need to decode any further frames.

If no more decoded samples are needed than provided by the current working frame, the procedure is ended as soon as all required samples have been provided.

Otherwise, the controller 32 orders the data storage component 11 to provide a next encoded frame f to the audio decoder 30 and determines whether this next encoded frame f comprises a loop start of a loop section, that is, whether f is identical to f₀.

If the next encoded frame f does not comprise a loop start, the controller 32 orders the audio decoder 30 to decode received frame f and to store it as working frame WF in data storage component 31.

If the next encoded frame f does comprise a loop start, the controller 32 verifies whether the internal state S₀ stored in the data storage component 34 is empty. Initially, it is empty, until the audio decoder 30 reaches the loop start for the first time.

If the internal state S₀ stored in data storage component 34 is empty, the controller 32 orders the audio decoder 30 to save the decoder internal state in S₀. Otherwise, the controller 32 orders the audio decoder 30 to restore the decoder internal state to S₀ as stored in data storage component 34.

In both cases, the controller 32 orders the audio decoder 30 thereupon as well to decode received frame f and to store it as working frame WF in data storage component 31.

Next, the controller 32 determines whether frame f comprises the loop end of a loop section, that is whether f is identical to f₁.

In case frame f does not comprise a loop end, f is incremented by one and the operation is continued with providing decoded samples from the working frame WF as described above. That is, a respective next frame f is decoded by the audio decoder 30, stored into the working frame WF and provided for audio frame generation, until the frame with the loop end is reached or until the requested number K of samples has been provided by data storage device 31.

In case frame f does comprise a loop end, f is set to f₀ again and the operation is continued with providing decoded samples from the working frame WF as described above. That is, frame f₀ is provided again by data storage component 11 to the audio decoder 30 and is decoded again using the same initial state S₀ as employed the first time by the audio decoder 30 for decoding frame f₀.

This loop unfolding process is repeated until the requested number K of samples has been provided by data storage device 31.

The operations performed by the controller 32 can be carried out by a hardware component, e.g. a control logic, and/or a software component 33 of the controller 32. In the latter case, the controller 32 can be given for example by a processor running the software 33.

It becomes apparent that the procedure described with reference to FIG. 3 allows to keep the memory requirements of the system to a minimum, in accordance with the first aspect of the invention, by storing no more than one decoded wavetable data frame at a time.

FIG. 4 is a flow chart illustrating the procedure followed on the encoding side of FIG. 2 for preparing input wavetable data for encoding in accordance with the second and the third aspect of the invention. The encoding is assumed to be carried out on a frame by frame basis, wherein a frame comprises more than one sample. FIG. 5 is a diagram illustrating by way of example samples which have been prepared in line with the procedure of FIG. 4 for a specific wavetable for encoding by the audio encoder 20.

When a wavetable comprising an attack section and a loop section is provided to the audio encoder 20, a distributing component 21 of the audio encoder 20 prepares a sequence of samples, including the wavetable samples, which are to be encoded on a frame-by-frame basis.

To this end, the distributing component 21 first determines a number of padding samples which have to be inserted at the beginning of the first frame, in order to ensure that the loop section begins close to the beginning of a frame.

Then, the distributing component 21 prepares the samples for the first frame by using first the determined number of padding samples having a value of zero, and thereupon the first values of the attack section of the received wavetable. This first frame is indicated in FIG. 5 as “Frame 0”. Next, the distributing component 21 prepares as many further frames as are required for accommodating the rest of the attack section. These frames are indicated in FIG. 5 as “Frame 1” to “Frame f₀”. The frame “Frame f₀” comprises only few or no samples from the attack section due to the padding samples at the beginning of “Frame 0”.

The frame “Frame f₀” is then filled up with samples of the loop section. If the loop section is shorter than one frame, there is a high probability that it will fit completely into the frame “Frame f₀”. Otherwise, the remaining samples of the loop section are distributed to further frames, indicated in FIG. 5 as “Frame f₀+1” to “Frame f₁”.

The last frame “Frame f₁” will usually not be filled up completely by the samples from the loop section. The audio encoder 20 therefore fills the last frame “Frame f₁” up by periodically extending the loop section.

If the encoding algorithm 22 of the audio encoder 20 is an encoding algorithm which collects the information needed to encode a frame from a windowed data segment larger than one frame, the periodic extension created in the distributing component 21 is somewhat longer than required to fill up the last, incomplete frame “Frame f₁”. The extension beyond the last frame is indicated in FIG. 5 as “Overhead”. The data exceeding the last frame boundary is not encoded by the encoding algorithm 22, but used in order to properly compress the last frame “Frame f₁” of the wavetable.

The preparation of the samples for encoding can be carried out by a hardware distributing component and/or a software distributing component 21. In the latter case, the audio encoder 20 can be for example given by a processor running the distributing software 21 and a software realizing the encoding algorithm 22.

It becomes apparent that the procedure described with reference to FIGS. 4 and 5 ensures, in accordance with the second aspect of the invention, that a loop section of a wavetable fits into a single frame whenever the length of the loop section is smaller than the frame length.

The described procedure is thus of advantage whenever the size of the loop section is smaller than the size of a frame. When the size of loop section is smaller than the frame size, this is not yet a guarantee in a conventional system that the entire loop section will be included in a single frame. For example, the loop section might start close to the end of frame f₀, such that the last part of the loop section extends into the next frame f₀+1. Consequently, during the playback, the frames f₀ and f₀+1 must be decoded several times in a row, in order to allow the loop section to be played as many times as required. In order to prevent such a situation, the presented procedure translates the frame boundaries such that the entire loop section is included in a single frame, if possible. When denoting by F the number of decoded samples in one frame, and by L the number of samples in the loop section of the wavetable, the frame boundary must be translated to the left such that the loop section starts in the 1st, the 2nd, . . . , or the (F-L)th sample of the frame in order to ensure that the entire loop section falls into this frame.

A straightforward solution would be to shift the start of a loop section to the first sample of a frame. However, some standards defining musical instruments in multimedia platforms, such as, for instance, “Downloadable Sounds Level 1” and “Downloadable Sounds Level 2.1”, both published by “The MIDI Manufactures Association (MMA)”, specify that a certain wavetable could be shared by several instruments. In this case, the start and the end of a loop section are not characteristic to the wavetable but rather to the instrument that utilizes the wavetable. Consequently, a single wavetable might have different loop start points during usage according to the instrument for which it is utilized.

Therefore, the process described with reference to FIGS. 4 and 5 requests only that the start of a loop section is close to the start of a frame such that the entire loop section is included in a single frame, provided that the size of the loop section is smaller than the size of the frame. This gives the opportunity to include possible other loop sections in the same wavetable beginning somewhat earlier equally entirely into the frame. In case it is not possible to fit all loop sections of a wavetable utilized by different instruments into a single frame due to the different start points of the loop sections, the frame boundaries could be translated for instance such that the desired advantage is only achieved for those instruments which are expected to be used often during playback. Of course, other strategies might be adopted as well.

Moreover, the procedure described with reference to FIGS. 4 and 5 ensures, in accordance with the third aspect of the invention, that the effect of boundary distortions is reduced, which occur whenever the last to be encoded frame is incomplete.

While there have been shown and described and pointed out fundamental novel features of the invention as applied to an embodiment thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A method for use in a wavetable based sound synthesis for which encoded wavetable data is decoded by means of an audio decoder on a frame-by-frame basis, each frame comprising at least one sample, wherein said encoded wavetable data comprises samples in an attack section and samples in a loop section, which samples of said loop section may be reused for a playback in a loop as often as required, said method comprising:
a) decoding consecutive frames of said wavetable data starting with a first frame up to a frame which includes a start of said loop section;
b) saving an internal state of said audio decoder before starting to decode said frame including the start of said loop section;
c) decoding subsequently all frames comprising samples of said loop section and providing said decoded frames for further processing for a playback; and
d) at least if said samples of said loop section are distributed to more than one frame, restoring said internal state of said audio decoder, saved at step b), and continuing with step c) as often as required.

2. The method according to claim 1, wherein each decoded frame is stored for said further processing by substituting a preceding frame in a storage component, and wherein a respective next frame is only decoded at a time when samples of a further frame are needed.

3. A device comprising:
an audio decoder decoding received wavetable data on a frame-by-frame basis, each frame comprising at least one sample, wherein said encoded wavetable data may comprise samples in an attack section and samples in a loop section, which samples of said loop section may be reused for a playback in a loop as often as required;
a storage component for saving an internal state of said audio decoder; and
a controller, which controller causes said audio decoder to save an internal state of said audio decoder into said storage component before decoding a next frame, if said next frame includes a start of a loop section, which controller causes said audio decoder to decode subsequently all frames comprising samples of said loop section and to provide said decoded frames for further processing for a playback, and which controller causes said audio decoder as often as required to restore said internal state saved in said storage component and to repeat decoding subsequently all frames comprising said samples of said loop section.

4. The device according to claim 3, further comprising a second storage component for storing the respective last decoded frame provided by said audio decoder and for providing samples of a respectively stored frame for further processing for a playback.

5. A wavetable based sound synthesis system comprising:
a first storage component for storing encoded wavetable data;
an audio encoder for encoding a wavetable on a frame-by-frame basis and for storing resulting wavetable data in said first storage component;
an audio decoder decoding wavetable data provided by said first storage component on a frame-by-frame basis, each frame comprising at least one sample, wherein said encoded wavetable data may comprise samples in an attack section and samples in a loop section, which samples of said loop section may be reused for a playback in a loop as often as required;
a second storage component for saving an internal state of said audio decoder; and
a controller, which controller causes said audio decoder to save an internal state of said audio decoder into said storage component before decoding a next frame, if said next frame includes a start of a loop section, which controller causes said audio decoder to decode subsequently all frames comprising samples of said loop section and to provide said decoded frames for further processing for a playback, and which controller causes said audio decoder as often as required to restore said internal state saved in said storage component and to repeat decoding subsequently all frames comprising said samples of said loop section.

6. A software program product in which a software code for supporting a wavetable based sound synthesis is stored, for which wavetable based sound synthesis encoded wavetable data is decoded by means of an audio decoder on a frame-by-frame basis, each frame comprising at least one sample, wherein said encoded wavetable data may comprise samples in an attack section and samples in a loop section, which samples of said loop section may be reused for a playback in a loop as often as required, said software code realizing the following steps when running in a processing component which is connected to said audio decoder:
causing said audio decoder to save an internal state of said audio decoder before decoding a next frame, if said next frame includes a start of a loop section;
causing said audio decoder to decode subsequently all frames comprising samples of said loop section and to provide said decoded frames for further processing for a playback; and
causing said audio decoder as often as required to restore said saved internal state and to repeat decoding subsequently all frames comprising said samples of said loop section.

7. A method for use in a wavetable based sound synthesis for which wavetable data is encoded for storage by means of an audio encoder on a frame-by-frame basis, each frame comprising more than one sample, wherein said wavetable data comprises samples in an attack section and samples in a loop section, which samples of said loop section may be reused for a playback in a loop as often as required, said method comprising:
distributing, in this order, a certain number of padding samples, said samples of said attack section and said samples of said loop section to a sequences of frames, wherein said certain number of padding samples is selected such that all samples of said loop section are included in a single frame in case said loop section comprises less samples than a respective frame; and
encoding said sequence of frames.

8. A device including an audio encoder for encoding received wavetable data on a frame-by-frame basis, each frame comprising more than one sample, wherein said wavetable data may comprise samples in an attack section and samples in a loop section and wherein samples of such a loop section may be reused for a playback in a loop as often as required, said audio encoder comprising:
a distributing component distributing, in this order, a certain number of padding samples, samples of an attack section of received wavetable data and samples of a loop section of received wavetable data to a sequences of frames, in case said received wavetable data includes an attack section and a loop section, said distributing component selecting said certain number of padding samples such that all samples of said loop section are included in a single frame in case said loop section comprises less samples than a respective frame; and
an encoding component for encoding a sequence of frames provided by said distributing component.

9. A wavetable based sound synthesis system comprising:
a storage component for storing encoded wavetable data;
an audio encoder for encoding received wavetable data on a frame-by-frame basis and for storing resulting wavetable data in said first storage component, each frame comprising more than one sample, wherein said wavetable data may comprise samples in an attack section and samples in a loop section and wherein samples of such a loop section may be reused for a playback in a loop as often as required, which audio encoder includes a distributing component distributing, in this order, a certain number of padding samples, samples of an attack section of received wavetable data and samples of a loop section of received wavetable data to a sequences of frames, in case said received wavetable data includes an attack section and a loop section, said distributing component selecting said certain number of padding samples such that all samples of said loop section are included in a single frame in case said loop section comprises less samples than a respective frame, and which audio encoder includes an encoding component for encoding a sequence of frames provided by said distributing component; and
an audio decoder decoding wavetable data received from said storage component on a frame-by-frame basis and providing decoded wavetable data for further processing for a playback.

10. A software program product in which a software code for supporting a wavetable based sound synthesis is stored, for which wavetable based sound synthesis received wavetable data is encoded for storage by means of an audio encoder on a frame-by-frame basis, each frame comprising more than one sample, wherein said wavetable data may comprise samples in an attack section and samples in a loop section, and wherein samples of such a loop section may be reused for a playback in a loop as often as required, said software code realizing the following steps when running in a processing component of said audio encoder:
distributing, in this order, a certain number of padding samples, samples of an attack section of received wavetable data and samples of a loop section of received wavetable data to a sequences of frames, in case said received wavetable data includes an attack section and a loop section, said distributing component selecting said certain number of padding samples such that all samples of said loop section are included in a single frame in case said loop section comprises less samples than a respective frame; and
providing said sequence of frames to an encoding component of said audio encoder for encoding.

11. A method for use in a wavetable based sound synthesis for which wavetable data is encoded for storage by means of an audio encoder on a frame-by-frame basis, each frame comprising more than one sample, wherein said wavetable data comprises samples in an attack section and samples in a loop section, which samples in said loop section may be reused for a playback in a loop as often as required, said method comprising:
distributing said samples of said wavetable data to a sequences of frames;
extending said loop section periodically in order to fill up a last frame of said sequence of frames with the resulting samples; and
encoding said sequence of frames.

12. The method of claim 11, wherein for encoding a specific frame said audio encoder uses samples from a window exceeding said specific frame, and wherein said loop section is extended periodically to obtain more samples than required for filling up said last frame, thereby providing samples for encoding said last frame based on samples from a window exceeding said last frame.

13. A device including an audio encoder for encoding received wavetable data on a frame-by-frame basis, each frame comprising more than one sample, wherein said wavetable data may comprise samples in an attack section and samples in a loop section and wherein samples of such a loop section may be reused for a playback in a loop as often as required, said audio encoder comprising:
a distributing component distributing samples of received wavetable data to a sequences of frames and, in case said received wavetable data comprises a loop section, extending said loop section periodically in order to fill up a last frame of said sequence of frames with the resulting samples; and
an encoding component for encoding a sequence of frames provided by said distributing component.

14. A wavetable based sound synthesis system comprising:
a storage component for storing encoded wavetable data;
an audio encoder for encoding received wavetable data on a frame-by-frame basis and for storing resulting wavetable data in said first storage component, each frame comprising more than one sample, wherein said wavetable data may comprise samples in an attack section and samples in a loop section and wherein samples of such a loop section may be reused for a playback in a loop as often as required, which audio encoder includes a distributing component distributing samples of received wavetable data to a sequences of frames and, in case said received wavetable data comprises a loop section, extending said loop section periodically in order to fill up a last frame of said sequence of frames with the resulting samples, and which audio encoder includes an encoding component for encoding a sequence of frames provided by said distributing component; and
an audio decoder decoding wavetable data received from said storage component on a frame-by-frame basis and providing decoded wavetable data for further processing for a playback.

15. A software program product in which a software code for supporting a wavetable based sound synthesis is stored, for which wavetable based sound synthesis received wavetable data is encoded for storage by means of an audio encoder on a frame-by-frame basis, each frame comprising more than one sample, wherein said wavetable data may comprise samples in an attack section and samples in a loop section, and wherein samples of such a loop section may be reused for a playback in a loop as often as required, said software code realizing the following steps when running in a processing component of said audio encoder:
distributing samples of received wavetable data to a sequences of frames;
in case said received wavetable data comprises a loop section, extending said loop section periodically in order to fill up a last frame of said sequence of frames with the resulting samples; and
providing said sequence of frames to an encoding component of said audio encoder for encoding.
